(19) United States
(12) Patent Application Publication
(10) Pub. No.: US 2026/0239208 A1
(43) Pub. Date: Aug. 13, 2026

(54) WAKE-UP SIGNAL TRANSMISSION METHOD AND APPARATUS

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/154,434

(22) PCT Filed: Feb. 16, 2023
(86) PCT No.: PCT/CN2023/076629

§ 371 Date: Aug. 7, 2025

(51) Int. Cl. H04W 52/02

(52) U.S. Cl. CPC H04W 52/0235

(57) ABSTRACT

The present disclosure relates to the technical field of communications, and particularly relates to a wake-up signal transmission method and apparatus. The method is executed by a network device, and includes: sending indication information to a user equipment, wherein the indication information is used for indicating a configuration for repeated transmission of a wake-up signal in a time domain, and the wake-up signal is used for instructing the user equipment to change the sleep state of a receiver.

### CROSS REFERENCE

The present application is a U.S. National Stage of International Application No. PCT/CN2023/076629, filed on Feb. 16, 2023, the contents of which are incorporated herein by reference in its entirety for all purposes.

### TECHNICAL FIELD

The present disclosure relates to the field of communication technologies, and in particular to a method and apparatus for transmitting a wake up signal.

### BACKGROUND

Terminals need to use Main Radios (MRs) when processing downlink data and/or uplink data, and the MRs do not always remain a wake-up state. After receiving Wake Up Signals (WUSs), the terminals will change sleep states of the MRs, and if the terminals do not receive the wake up signals or the received wake up signals indicate that the MRs should not wake up, the terminals will keep the MRs in the sleep state.

### SUMMARY

The present disclosure provides a method and apparatus for transmitting a wake up signal.

According to a first aspect of embodiments of the present disclosure, there is provided a method for transmitting a wake up signal, which is performed by a network device, and the method includes:
sending indication information to a user equipment, wherein the indication information is configured to indicate a configuration for repeated transmission of a wake up signal in a time domain, and the wake up signal is configured to indicate to the user equipment to change a sleep state of a receiver.

According to a second aspect of embodiments of the present disclosure, there is provided a method for transmitting a wake up signal, which is performed by a user equipment, and the method includes:
receiving indication information sent by a network device, wherein the indication information is configured to indicate a configuration for repeated transmission of a wake up signal in a time domain, and the wake up signal is configured to indicate to a user equipment to change a sleep state of a receiver.

According to a third aspect of embodiments of the present disclosure, there is provided a network device, including:
a processor; and
a memory configured to store executable instructions of the processor;
wherein the processor is configured to implement the method for transmitting the wake up signal provided in the first aspect of embodiments of the present disclosure when executing the executable instructions.

According to a fourth aspect of embodiments of the present disclosure, there is provided a user equipment, including:
a processor; and
a memory configured to store executable instructions of the processor;
wherein the processor is configured to implement the method for transmitting the wake up signal provided in the second aspect of embodiments of the present disclosure when executing the executable instructions.

According to a fifth aspect of embodiments of the present disclosure, there is provided a computer-readable storage medium having computer program instructions stored thereon, wherein the program instructions, when executed by a processor, implement the method for transmitting the wake up signal provided in the first aspect of embodiments of the present disclosure or implement the method for transmitting the wake up signal provided in the second aspect of embodiments of the present disclosure.

According to a sixth aspect of embodiments of the present disclosure, there is provided a chip, including a processor and an interface; the processor is configured to read instructions to execute the method for transmitting the wake up signal provided in the first aspect of embodiments of the present disclosure or execute the method for transmitting the wake up signal provided in the second aspect of embodiments of the present disclosure.

### BRIEF DESCRIPTION OF THE DRAWINGS

The accompanying drawings here, which are incorporated in and constitute a part of this specification, illustrate embodiments consistent with the present disclosure and, together with the description, serve to explain principles of the present disclosure.

FIG. 1 shows a flowchart of a method for transmitting a wake up signal according to an example embodiment.

FIG. 2 shows a flowchart of a method for transmitting a wake up signal according to an example embodiment.

FIG. 3 shows a schematic diagram of a wake up signal occupying a slot of a channel according to an example embodiment.

FIG. 4 shows a schematic diagram of a wake up signal occupying a symbol of a channel according to an example embodiment.

FIG. 5 shows a flowchart of a method for transmitting a wake up signal according to an example embodiment.

FIG. 6 shows a flowchart of a method for transmitting a wake up signal according to an example embodiment.

FIG. 7 shows a flowchart of a method for transmitting a wake up signal according to an example embodiment.

FIG. 8 shows a flowchart of a method for transmitting a wake up signal according to an example embodiment.

FIG. 9 shows a flowchart of a method for transmitting a wake up signal according to an example embodiment.

FIG. 10 shows a flowchart of a method for transmitting a wake up signal according to an example embodiment.

FIG. 11 shows a flowchart of a method for transmitting a wake up signal according to an example embodiment.

FIG. 12 shows a flowchart of a method for transmitting a wake up signal according to an example embodiment.

FIG. 13 shows a schematic diagram of partial information of a wake up signal before and after expansion in a time domain according to an example embodiment.

FIG. 14 shows a schematic diagram of partial information of a wake up signal before and after expansion in a time domain according to an example embodiment.

FIG. 15 shows a block diagram of an apparatus for transmitting a wake up signal according to an example embodiment.

FIG. 16 shows a block diagram of an apparatus for transmitting a wake up signal according to an example embodiment.

FIG. 17 shows a block diagram of an apparatus for transmitting a wake up signal according to an example embodiment.

FIG. 18 shows a block diagram of an apparatus for transmitting a wake up signal according to an example embodiment.

FIG. 19 shows a block diagram of an apparatus for transmitting a wake up signal according to an example embodiment.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with the present disclosure. Instead, they are merely examples of apparatuses and methods consistent with some aspects of the present disclosure as recited in the appended claims.

It can be understood that in the present disclosure, “a plurality” or “multiple” refers to two or more, and other quantifiers are analogous to it. “And/or” is used to describe an associated relationship between associated objects and means three relationships, for instance, A and/or B may mean A alone, A and B together, and B alone. The character “/” generally indicates that the associated objects are in an “or” relationship. Singular forms “a”, “an” and “the” are intended to include plural forms as well, unless the context clearly indicates otherwise.

It can be understood that indication information proposed in the present disclosure is an illustrative description of information, and the indication information may also be referred to as first information, second information, configuration information, etc., which is not limited by the present disclosure.

It can be further understood that the terms “first”, “second”, etc. are used to describe various information, but the information should not be limited by these terms. These terms are merely used to distinguish the same type of information from each other and do not denote a particular order or degree of importance. Indeed, the expressions “first”, “second”, etc. may be used interchangeably. For example, without departing from the scope of the present disclosure, a first wake up signal may also be referred to as a second wake up signal, and similarly, the second wake up signal may also be referred to as the first wake up signal.

It can be further understood that although the operations in embodiments of the present disclosure are described in a specific order in the drawings, they should not be understood as requiring that the operations are performed in the specific order shown or in a serial order, or that all the operations shown are performed to get the desired result. In certain environments, multitasking and parallel processing may be advantageous.

It is to be noted that all actions of obtaining a signal, information or data in the present disclosure are performed under the premise of complying with the corresponding data protection regulations and policies of the local country, and with authorization of the corresponding apparatus owner.

In the related arts, a base station sends a wake up signal to a terminal, and the terminal changes a sleep state of a receiver based on the wake up signal. The receiver can only process uplink data and/or downlink data after it is in a wake-up state. Typically, the number of wake up signals sent by the base station is one. In the case of weak signal strength or transmission error, the terminal may be unable to receive the wake up signal, resulting in the receiver not being able to be woken up normally.

In order to ensure that the receiver can be woken up normally, the base station can send at least two wake up signals to the terminal. In this way, when the signal strength varies between high and low levels, even if a strength for transmitting one of the wake up signals is higher, a strength for transmitting the remaining wake up signals may be increased, so that the terminal can receive the wake up signal. If one of the wake up signals is transmitted incorrectly, the remaining wake up signals are transmitted correctly, which can also ensure that the terminal can receive the correct wake up signal. On this basis, the terminal can change the sleep state of the receiver according to the received wake up signal.

Therefore, in order to ensure that the base station can send the at least two wake up signals to the terminal, the present disclosure needs to define a resource configuration for transmitting the at least two wake up signals, so that the at least two wake up signals can be successfully transmitted between the base station and the terminal.

FIG. 1 shows a method for transmitting a wake up signal according to an example embodiment. The method is performed by a network device and includes the following step:
in step S101, indication information is sent to a user equipment, the indication information is configured to indicate a configuration for repeated transmission of a wake up signal in a time domain, and the wake up signal is configured to indicate to the user equipment to change a sleep state of a receiver.

The network device proposed in any embodiment of the present disclosure may be a device for communicating with the user equipment, and the network device may also be referred to as an access network device or a radio access network device. The network device may be a transmission reception point (TRP), or an evolved NodeB (eNB or eNodeB) in an LTE system, or a home base station (e.g., home evolved NodeB, or home Node B, HNB), a base band unit (BBU), or a wireless controller in a cloud radio access network (CRAN) scenario. Alternatively, the network device may be a relay station, an access point, a vehicle-mounted device, a wearable device, a network device in a 5G network, or a network device in a future evolved PLMN network, etc., and may be an access point (AP) in a WLAN, or a gNB of an NR, which is not limited in embodiments of the present disclosure. For ease of reading, the network device will be referred to as a base station below.

The user equipment proposed in any embodiment of the present disclosure may be a mobile phone, a tablet, a portable computer, a computer with wireless transceiver function, a virtual reality (VR) terminal device, an augmented reality (AR) terminal device, a wireless terminal in industrial control, a wireless terminal in a smart grid, a wireless terminal in transportation safety, a wireless terminal in a smart city, a wireless terminal in a smart home, etc. The present disclosure does not limit the application scenario, and the user equipment may sometimes also be referred to as a terminal device, a terminal, an access terminal, a UE unit, a UE station, a mobile device, a station, a mobile station, a mobile client, etc. For ease of reading, the user equipment will be referred to as a terminal hereinafter.

The terminal is provided with a receiver, which is also called a main radio. The receiver is used to receive and process downlink data and/or uplink data. When the terminal receives a low power wake up signal (LP WUS), the terminal will change the sleep state of the receiver, or the terminal will be directly woken up. If the terminal does not receive the low power wake up signal or the low power wake up signal indicates not to wake up, the terminal will keep the sleep state of the receiver, or make the receiver enter a deeper sleep state. There are five sleep states of the receiver: Ultra-deep sleep, Deep Sleep, Light Sleep, Micro sleep, and normal.

The indication information may be signaling, and the signaling may be at least one of downlink control information (DCI), media access control control element (MAC CE), or radio resource control (RRC).

For example, the base station may send the at least one of the DCI, the MAC CE or the RRC to indicate, in the at least one of the DCI, the MAC CE or the RRC, the configuration for the repeated transmission of the wake up signal in the time domain.

The repeated transmission of the wake up signal in the time domain refers to the base station repeatedly transmitting the wake up signal to the terminal in the time domain. The configuration for the repeated transmission of the wake up signal in the time domain refers to a resource configuration occupied by at least two wake up signals on the channel. The base station determines, based on a resource occupied by the wake up signal on the channel, a resource position for sending the wake up signal, and the terminal determines, based on the resource occupied by the wake up signal on the channel, a resource position for receiving the wake up signal. It can be understood that the resource position where the base station sends the wake up signal is typically the same as the resource position where the terminal receives the same wake up signal.

After the base station adopts the configuration for the repeatedly transmission of the wake up signal in the time domain, and sends the at least two wake up signals to the terminal, the terminal can change the sleep state of the receiver according to one of the at least two wake up signals.

It can be understood that the purpose of the base station sending the at least two wake up signals is to enable the terminal to successfully receive a reliable wake up signal to successfully change the sleep state of the receiver, so as to avoid the receiver being unable to be woken up in time.

Among the at least two wake up signals transmitted by the base station, time domain resources occupied by two adjacent wake up signals are the same, and frequency domain resources occupied by the two adjacent wake up signals are also the same.

For example, for the time domain resource, the time domain resources occupied by the two adjacent wake up signals, such as the number of slots or the number of symbols, are the same.

For example, for the frequency domain resource, the frequency domain resources occupied by the two adjacent wake up signals, such as resource grids (RGs), resource elements (REs), resource blocks (RB), resource block groups (RBGs), resource element groups (REGs), control channel elements (CCEs) and bandwidth parts (BWPs), or frequency bands, are the same.

It can be understood that the information indicates the configuration for the repeated transmission of the wake up signal in the time domain, and the information includes first information and/or second information, the first information indicates the number of repetitions of the repeated transmission of the wake up signal, an offset, etc., and the second information indicates a time domain expansion configuration of the wake up signal in the time domain. After the wake up signal is expanded in the time domain, the wake up signal can also be replicated in the time domain for repeated transmission. The terminal can determine, according to the first information and/or the second information, the resource position where the base station sends the wake up signal.

It can be understood that the wake up signal proposed in the present disclosure includes a low power wake up signal (LP WUS).

Through the above technical solution, the base station can send the indication information to the terminal, and the indication information indicates the configuration for the repeated transmission of the wake up signal in the time domain, so that the terminal determines, based on the configuration for the repeated transmission of the wake up signal in the time domain, at which resource positions the terminal itself receives the repeatedly transmitted wake up signal, and then the terminal uses at least one wake up signal among the received at least two wake up signals to change the sleep state of the receiver and complete the reception and transmission of uplink data and/or downlink data.

FIG. 2 shows a method for transmitting a wake up signal according to an example embodiment. The method is performed by a network device and includes the following step:
in step S201, first information is sent to a user equipment, and a configuration indicated by the first information includes at least one of: the number of repetitions of the repeated transmission of the wake up signal; or an offset between two adjacent wake up signals; or a position in the time domain of a repeatedly transmitted wake up signal among wake up signals; or a time domain resource occupied by the repeatedly transmitted wake up signal among the wake up signals.

The number of repetitions of the repeated transmission of the wake up signal refers to the number of times that the base station repeatedly sends the wake up signal. For example, when the number of repetitions of the wake up signal is 2, the number of times that the base station sends the wake up signal is 2.

The offset between the two adjacent wake up signals refers to the number of bytes by which the subsequent wake up signal among the two adjacent wake up signals is shifted backward relative to the preceding one, or the number of bytes by which the preceding wake up signal among the two adjacent wake up signals is shifted forward relative to the subsequent one. A granularity of the offset can be a radio frame, a sub-frame, a slot, and a symbol, etc., which is not limited in the present disclosure. The two adjacent wake up signals can be the first and second wake up signals sent by the base station, or the second and third wake up signals sent by the base station, etc.

In some implementations, after the number of repetitions of the wake up signal and the offset between the two adjacent wake up signals are determined, resource positions of the at least two wake up signals in a channel may be determined.

For example, the number of repetitions of the wake up signal is 2, and a starting position of the first wake up signal occupies the 3rd symbol in slot0. If the offset is 2 symbols, a starting position of the second wake up signal occupies the 5th symbol in slot0. In this case, it can be determined that the base station sends the second wake up signal at the 5th symbol in slot0.

For example, the number of repetitions of the wake up signal is 2, and a starting position of the first wake up signal occupies the 3rd symbol in slot0. If a time domain symbol offset is 2 symbols and a slot offset is one slot, then a starting position of the second wake up signal occupies the 5th symbol in slot1. In this case, it can be determined that the base station sends the second wake up signal at the 5th symbol in slot1.

The position in the time domain of the repeatedly transmitted wake up signal among the wake up signals can be the first resource in the channel occupied by the repeatedly transmitted wake up signal among the wake up signals. A granularity of the first resource can be a radio frame, a sub-frame, a slot, a symbol, etc., which is not limited by the present disclosure. The position in the time domain of the repeatedly transmitted wake up signal among the wake up signals can be a resource position in the time domain of any repeatedly transmitted wake up signal after the first wake up signal sent by the base station.

The time domain resource occupied by the repeatedly transmitted wake up signal among the wake up signals can be a time domain length occupied by the repeatedly transmitted wake up signal among the wake up signals. A granularity of the occupied time domain resource can be a radio frame, a sub-frame, a slot, a symbol, etc., which is not limited by the present disclosure. The time domain resource occupied by the repeatedly transmitted wake up signal among the wake up signals can be a time domain resource occupied by any repeatedly transmitted wake up signal after the first wake up signal sent by the base station.

For the time domain resource, the radio frame, the sub-frame, the slot and the symbol are included. A length of a radio frame is typically 10 ms, a radio frame contains 10 sub-frames, and each sub-frame is 1 ms. The number of slots contained in a sub-frame may be any one of 1, 2, 4, 8, or 16, and a slot contains 12 or 14 symbols. In a 4G network, scheduling is performed in units of sub-frames, and in a 5G network, scheduling is performed in units of slots.

Through the above technical solution, the base station can send the first information to the terminal. Since the first information carries the at least one of the number of repetitions of the repeated transmission of the wake up signal, the offset between the two adjacent wake up signals, the position in the time domain of the repeatedly transmitted wake up signal, or the time domain resource occupied by the repeatedly transmitted wake up signal among the wake up signals, the terminal can determine, based on at least one of the four pieces of information, the resource position of each wake up signal in the time domain, thereby determining the resource position where the terminal itself receives the wake up signal.

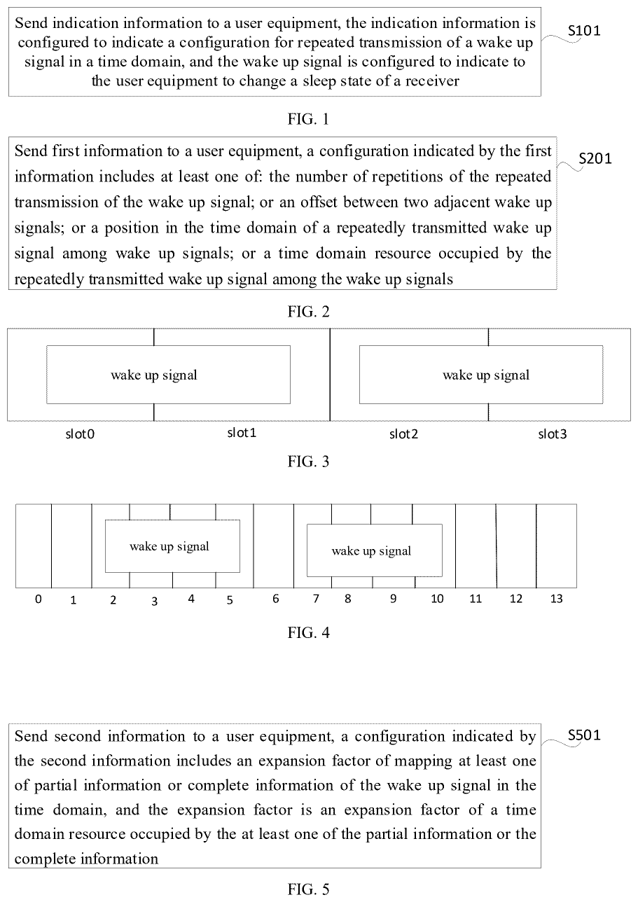

FIG. 3 shows a schematic diagram of an offset according to an example embodiment. An offset between two wake up signals in the time domain includes at least one of the following (1), (2), or (3).
(1) The number of slots offset between the two adjacent wake up signals.

When a granularity of the offset is at a slot level, the offset between the two adjacent wake up signals is the number of slots offset between the two adjacent wake up signals.

The number of slots offset between the two adjacent wake up signals includes the number of slots offset between a first slot carrying a first wake up signal among the two adjacent wake up signals and a second slot carrying a second wake up signal among the two adjacent wake up signals, the first slot includes a starting slot and an ending slot carrying the first wake up signal, and the second slot includes a starting slot and an ending slot carrying the second wake up signal.

For example, the offset may be the number of slots offset between a starting slot of a channel carrying the first wake up signal among the two adjacent wake up signals and a starting slot of a channel carrying the second wake up signal among the two adjacent wake up signals.

Referring to FIG. 3, if the first wake up signal occupies slot0 and slot1 of the channel, and the second wake up signal occupies slot2 and slot3 of the channel, then the starting slot carrying the first wake up signal is slot0, the starting slot carrying the second wake up signal is slot2, and the offset is 2 slots.

For example, the offset may be the number of slots offset between the starting slot of the channel carrying the first wake up signal among the two adjacent wake up signals and an ending slot of the channel carrying the second wake up signal among the two adjacent wake up signals.

Referring to FIG. 3, if the first wake up signal occupies slot0 and slot1 of the channel, and the second wake up signal occupies slot2 and slot3 of the channel, then the starting slot carrying the first wake up signal is slot0, the ending slot carrying the second wake up signal is slot3, and the offset is 3 slots.

For example, the offset may be the number of slots offset between an ending slot of the channel carrying the first wake up signal among the two adjacent wake up signals and the starting slot of the channel carrying the second wake up signal among the two adjacent wake up signals.

Referring to FIG. 3, if the first wake up signal occupies slot0 and slot1 of the channel, and the second wake up signal occupies slot2 and slot3 of the channel, then the ending slot carrying the first wake up signal is slot1, the starting slot carrying the second wake up signal is slot2, and the offset is 1 slot.

For example, the offset may be the number of slots offset between the ending slot of the channel carrying the first wake up signal among the two adjacent wake up signals and the ending slot of the channel carrying the second wake up signal among the two adjacent wake up signals.

Referring to FIG. 3, if the first wake up signal occupies slot0 and slot1 of the channel, and the second wake up signal occupies slot2 and slot3 of the channel, then the ending slot carrying the first wake up signal is slot1, the ending slot carrying the second wake up signal is slot3, and the offset is 2 slots.
(2) The number of symbols offset between the two adjacent wake up signals.

When the granularity of the offset is at a symbol level, the offset between the two adjacent wake up signals is the number of symbols offset between the two adjacent wake up signals.

The number of symbols offset between the two adjacent wake up signals includes the number of symbols offset between a first symbol carrying the first wake up signal among the two adjacent wake up signals and a second symbol carrying the second wake up signal among the two adjacent wake up signals, the first symbol includes a starting symbol and an ending symbol carrying the first wake up signal, and the second symbol includes a starting symbol and an ending symbol carrying the second wake up signal.

For example, the offset may be the number of symbols offset between a starting symbol of a channel carrying the first wake up signal among the two adjacent wake up signals and a starting symbol of a channel carrying the second wake up signal among the two adjacent wake up signals.

Referring to FIG. 4, if the first wake up signal occupies the second symbol to the fifth symbol of slot0, and the second wake up signal occupies the seventh symbol to the tenth symbol of slot0, then the starting symbol carrying the first wake up signal is the second symbol in slot0, the starting symbol carrying the second wake up signal is the seventh symbol in slot0, and the offset is 5 symbols in slot0.

For example, the offset may be the number of symbols offset between the starting symbol of the channel carrying the first wake up signal among the two adjacent wake up signals and an ending symbol of the channel carrying the second wake up signal among the two adjacent wake up signals.

Referring to FIG. 4, if the first wake up signal occupies the second symbol to the fifth symbol of slot0, and the second wake up signal occupies the seventh symbol to the tenth symbol of slot0, then the starting symbol carrying the first wake up signal is the second symbol in slot0, the ending symbol carrying the second wake up signal is the tenth symbol in slot0, and the offset is 8 symbols in slot0.

For example, the offset may be the number of symbols offset between an ending symbol of the channel carrying the first wake up signal among the two adjacent wake up signals and the starting symbol of the channel carrying the second wake up signal among the two adjacent wake up signals.

Referring to FIG. 4, if the first wake up signal occupies the second symbol to the fifth symbol of slot0, and the second wake up signal occupies the seventh symbol to the tenth symbol of slot0, then the ending symbol carrying the first wake up signal is the fifth symbol in slot0, the starting symbol carrying the second wake up signal is the seventh symbol in slot0, and the offset is 2 symbols in slot0.

For example, the offset may be the number of symbols offset between the ending symbol of the channel carrying the first wake up signal among the two adjacent wake up signals and the ending symbol of the channel carrying the second wake up signal among the two adjacent wake up signals.

Referring to FIG. 4, if the first wake up signal occupies the second symbol to the fifth symbol of slot0, and the second wake up signal occupies the seventh symbol to the tenth symbol of slot0, then the ending symbol carrying the first wake up signal is the fifth symbol in slot0, the ending symbol carrying the second wake up signal is the tenth symbol in slot0, and the offset is 5 symbols in slot0.
(3) The absolute time interval offset between the two adjacent wake up signals.

When the granularity of the offset is time, the offset between the two adjacent wake up signals is the absolute time interval offset between the two adjacent wake up signals.

The absolute time interval offset between the two adjacent wake up signals includes an absolute time interval between a first absolute time of the first wake up signal among the two adjacent wake up signals and a second absolute time of the second wake up signal among the two adjacent wake up signals, the first absolute time may be an absolute time of a starting position where the base station sends the first wake up signal or an absolute time of an ending position where the base station sends the first wake up signal, and the second absolute time may be an absolute time of a starting position where the base station sends the second wake up signal or an absolute time of an ending position where the base station sends the second wake up signal.

The absolute time interval may be 0-5000 us or 0-5000 ms, etc., which is not limited by the present disclosure.

For example, the offset may be an absolute time interval between the absolute time of the starting position where the base station sends the first wake up signal and the absolute time of the starting position where the base station sends the second wake up signal.

For example, the offset may be an absolute time interval between the absolute time of the starting position where the base station sends the first wake up signal and the absolute time of the ending position where the base station sends the second wake up signal.

For example, the offset may be an absolute time interval between the absolute time of the ending position where the base station sends the first wake up signal and the absolute time of the starting position where the base station sends the second wake up signal.

For example, the offset may be an absolute time interval between the absolute time of the ending position where the base station sends the first wake up signal and the absolute time of the ending position where the base station sends the second wake up signal.

It can be understood that absolute time does not change with external actions or observers, and the absolute time is a standard time.

Through the above technical solution, the base station can indicate, in the first information, the offset in the time domain between the two adjacent wake up signals, so that the terminal determines the resource position of each wake up signal based on the offset, and then receives the repeatedly transmitted wake up signal at the resource position.

According to a schematic diagram of a position of a repeatedly transmitted wake up signal in the time domain shown in an example embodiment, the position in the time domain of the repeatedly transmitted wake up signal among the wake up signals includes at least one of the following (4) or (5).
(4) An initial slot carrying the repeatedly transmitted wake up signal.

The position of the repeatedly transmitted wake up signal in the time domain may be the initial slot carrying the repeatedly transmitted wake up signal, and the initial slot is not an initial slot of the channel, but a slot, in the channel, occupied by a starting position of the wake up signal. The initial slot may also be referred to as the starting slot or the first slot.

For example, a sub-frame of a channel has 8 slots, that is, slot0 to slot7. The starting position of the second wake up signal occupies slot2, so the initial slot carrying the second wake up signal is slot2; the starting position of the third wake up signal occupies slot5, so the initial slot carrying the third wake up signal is slot5. Both the second wake up signal and the third wake up signal can be understood as wake up signals that are repeatedly transmitted after the first wake up signal.
(5) An initial symbol carrying the repeatedly transmitted wake up signal.

The position of the repeatedly transmitted wake up signal in the time domain may be the initial symbol carrying the repeatedly transmitted wake up signal, and the initial symbol is not an initial symbol of the channel, but a symbol, in the channel, occupied by the starting position of the wake up signal.

For example, referring to FIG. 4, a slot of a channel has 14 symbols from the 0th symbol to the thirteenth symbol, the starting position of the second wake up signal occupies the second symbol, then the initial symbol carrying the second wake up signal is the second symbol; and the starting position of the third wake up signal occupies the seventh symbol, then the initial symbol carrying the third wake up signal is the seventh symbol.

It can be understood that the base station can indicate, in the first information, not only the position in the time domain of the starting position of the repeatedly transmitted wake up signal, but also the position in the time domain of the ending position of the repeatedly transmitted wake up signal, which is not limited by the present disclosure.

Through the above technical solution, the base station can indicate, in the first information, the position in the time domain of the starting position of the repeatedly transmitted wake up signal, and the terminal can determine, based on the position in the time domain of the starting position of the repeatedly transmitted wake up signal, a starting resource occupied by each repeatedly transmitted wake up signal in the channel, and receive each repeatedly transmitted wake up signal on the starting resource.

FIG. 3 and FIG. 4 show schematic diagrams of a time domain resource occupied by a repeatedly transmitted wake up signal according to an example embodiment. The time domain resource occupied by the repeatedly transmitted wake up signal among the wake up signals includes at least one of the following (6) or (7).
(6) The number of slots occupied by the repeatedly transmitted wake up signal.

For example, referring to FIG. 3, the number of slots occupied by the wake up signal is 2.
(7) The number of symbols occupied by the repeatedly transmitted wake up signal.

For example, referring to FIG. 4, the number of symbols occupied by the wake up signal is 4.

It can be understood that the time domain resource occupied by the repeatedly transmitted wake up signal may be the time domain length occupied by the repeatedly transmitted wake up signal. For example, the occupied time domain length may be the number of occupied slots or the number of occupied symbols.

Through the above technical solution, the base station can indicate, in the first information, the amount of time domain resources occupied by the repeatedly transmitted wake up signal, and the terminal determines the time domain length occupied by the repeatedly transmitted wake up signal according to the amount of time domain resources.

FIG. 5 shows a method for transmitting a wake up signal according to an example embodiment. The method is performed by a network device and includes the following step:
in step S501, second information is sent to a user equipment, a configuration indicated by the second information includes an expansion factor of mapping at least one of partial information or complete information of the wake up signal in the time domain, and the expansion factor is an expansion factor of a time domain resource occupied by the at least one of the partial information or the complete information.

The indication information may also be the second information, the second information includes third information and/or fourth information, the third information includes the expansion factor of mapping the at least one of the partial information or the complete information of the wake up signal in the time domain, and the fourth information includes the configuration in which the at least one of the partial information or the complete information of the wake up signal is replicated in the time domain.

The expansion factor of mapping the at least one of the partial information or the complete information of the wake up signal in the time domain means that a time domain length, mapped in the time domain, of the at least one of the partial information or the complete information of the wake up signal after expansion is N times a time domain length, mapped in the time domain, of the at least one of the partial information or the complete information of the wake up signal before expansion, and the value N is the expansion factor.

For example, the time domain length, mapped in the time domain, of the wake up signal before expansion is 6 symbols, and the time domain length, mapped in the time domain, of the wake up signal after expansion is 12 symbols, so the expansion factor is 2.

It can be understood that the time domain length, mapped in the time domain, of the at least one of the partial information or the complete information of the wake up signal refers to a time domain length occupied by the at least one of the partial information or the complete information of the wake up signal on the channel.

Mapping and expanding the at least one of the partial information or the complete information of the wake up signal in the time domain can be regarded as increasing the time domain length occupied by the at least one of the partial information or the complete information of the wake up signal.

In some implementations, after receiving the resource configuration and the expansion factor of the at least one of the partial information or the complete information of the wake up signal, the terminal may determine the resource position in the time domain of the at least one of the partial information or the complete information of the wake up signal after expansion.

For example, referring to FIG. 13, when the resource configuration received by the terminal indicates that the symbol occupied by the starting position of the wake up signal is the second symbol, the time domain length occupied by the wake up signal is 5 symbols, and the expansion factor is 2, then the terminal can determine, according to the expansion factor and the time domain length occupied by the wake up signal, that the time domain length occupied by the expanded wake up signal in the time domain is 10 symbols and then determine that the wake up signal is transmitted at the resource position which is at the second symbol and continues for 10 symbols.

Through the above technical solution, the base station can send the second information to the terminal, and the second information indicates the expansion factor of mapping the at least one of the partial information or the complete information of the wake up signal in the time domain, and then the terminal can determine, according to the expansion factor, the time domain length, mapped in the time domain, of the partial information and the complete information of the wake up signal.

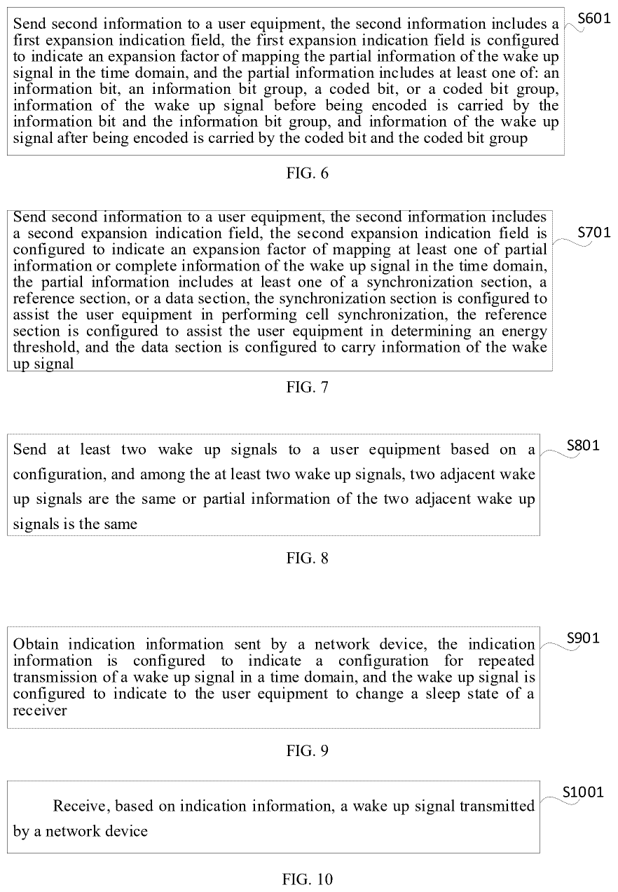

FIG. 6 shows a method for transmitting a wake up signal according to an example embodiment. The method is performed by a network device and includes the following step:
in step S601, second information is sent to a user equipment, the second information includes a first expansion indication field, the first expansion indication field is configured to indicate an expansion factor of mapping the partial information of the wake up signal in the time domain, and the partial information includes at least one of: an information bit, an information bit group, a coded bit, or a coded bit group, information of the wake up signal before being encoded is carried by the information bit and the information bit group, and information of the wake up signal after being encoded is carried by the coded bit and the coded bit group.

The indication information may be the second information, the second information carries the first expansion indication field, and the first expansion indication field is configured to indicate the expansion factor.

For example, when the first expansion indication field is 2, the partial information before expansion occupies one symbol of a channel, and the partial information after expansion occupies two symbols of the channel.

The base station encodes the wake up signal into information bits, and then encodes the information bits into coded bits through multi-carrier binary on-off key (MC-OOK) modulation or amplitude shift keying (ASK) modulation. The base station then modulates the coded bits of the wake up signal into a carrier signal and inputs it into the channel, which is transmitted to the terminal through the channel. The information bits reflect information conveyed by the wake up signal, and the information bits can only be transmitted in the channel after being encoded into the coded bits. The process of the base station encoding the wake up signal into the information bits is called source coding, and the process of encoding the information bits into the coded bits is called channel coding. The source coding can remove redundant information in the wake up signal, and the channel coding can ensure the reliability of the transmitted wake up signal.

The partial information of the wake up signal may be an information bit or an information bit group or a coded bit or a coded bit group of the wake up signal. An information bit group includes at least two information bits, and a coded bit group includes at least two coded bits.

Referring to FIG. 13, taking one information bit occupying one symbol as an example, each of five information bits 10001 of the wake up signal before expansion occupies one symbol, and a total of five symbols are occupied. Each of the five information bits 10001 after expansion occupies two symbols, and a total of ten symbols are occupied.

Through the above-mentioned technical solution, the base station can send the second information to the terminal, and the first expansion indication field carried in the second information indicates the expansion factor in the time domain of the at least one of the information bit, the information bit group, the coded bit, or the coded bit group of the wake up signal, so that the terminal can determine, based on the expansion factor, the resource position of the at least one of the information bit, the information bit group, the coded bit, or the coded bit group of the received wake up signal.

FIG. 7 shows a method for transmitting a wake up signal according to an example embodiment. The method is performed by a network device and includes the following step:
in step S701, second information is sent to the user equipment, the second information includes a second expansion indication field, the second expansion indication field is configured to indicate an expansion factor of mapping at least one of partial information or complete information of the wake up signal in the time domain, the partial information includes at least one of a synchronization section, a reference section, or a data section, the synchronization section is configured to assist the user equipment in performing cell synchronization, the reference section is configured to assist the user equipment in determining an energy threshold, and the data section is configured to carry information of the wake up signal.

The indication information may be the second information, the second information carries the second expansion indication field, and the second expansion indication field is configured to indicate the expansion factor.

The information bit or the coded bit of the synchronization section and the reference section will not change in most cases, and the information bit of the data section carries the information of the wake up signal, so it may change. The synchronization section carries the cell information covered by the base station and is configured to assist the terminal in performing the time-frequency synchronization. The reference section is configured to assist the terminal in determining the energy threshold. For example, when the energy threshold initially determined by the terminal is A, and the energy of the information bit sent by the base station is A, if the energy of the information bit sent by the base station which is transmitted to the terminal after attenuation is only 0.6 A, the terminal will adjust the energy threshold A to 0.6 A. The energy threshold is used to provide a reference threshold for the energy of the information bit accumulated by the terminal. When the information bit or the coded bit received by the terminal is 1, the terminal will accumulate the energy, and when the information bit or the coded bit received by the terminal is 0, the terminal will not accumulate the energy. The data section is configured to carry the information of the wake up signal, such as cell/carrier indication information, power control information, bandwidth part indication information, secondary cell deactivation information, reference signal request information, multiple-input multiple-output (MIMO) layer indication information, cancellation information, cross-slot scheduling indication information, etc.

The partial information of the wake up signal can be the at least one of the synchronization section, the reference section, or the data section of the wake up signal. The second expansion indication field can indicate the expansion factor in the time domain of the at least one of the synchronization section, the reference section, or the data section of the wake up signal, and can also indicate the time domain expansion factor of the entire wake up signal in the time domain.

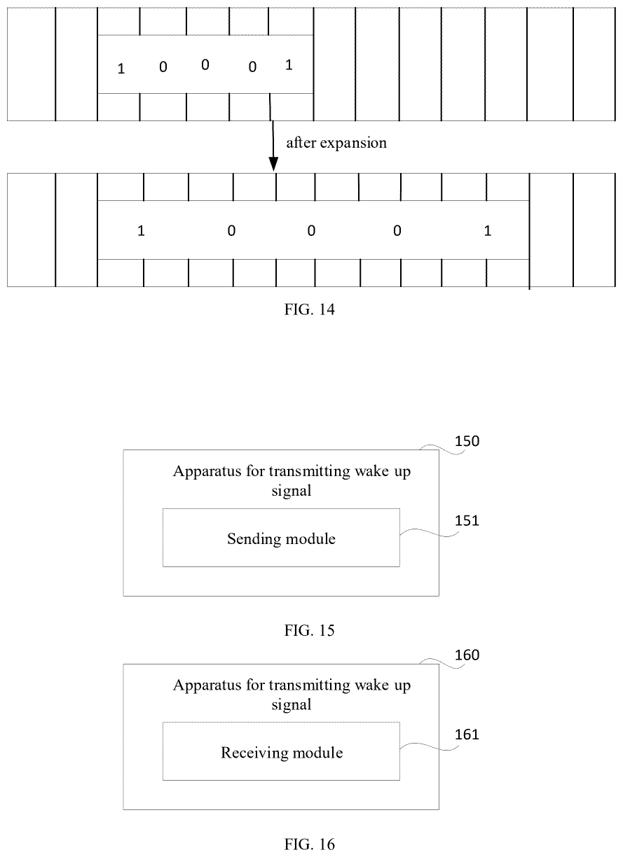

Referring to FIG. 14, if the five information bits 10001 in FIG. 14 represent the data section of the wake up signal, then the data section before expansion occupies five symbols, and the data section after expansion occupies ten symbols.

Referring to FIG. 14, if the five information bits 10001 in FIG. 14 represent a wake up signal, then the wake up signal before expansion occupies five symbols, and the wake up signal after expansion occupies ten symbols.

In some implementations, when the synchronization section, the reference section, and the data section of the wake up signal or the entire wake up signal is mapped and expanded, the time domain length, mapped on the channel, of the synchronization section, the reference section, and the data section of the wake up signal or the entire wake up signal can be expanded, but the information of the synchronization section, the reference section, and the data section of the wake up signal or the entire wake up signal remains unchanged.

For example, referring to FIG. 14, which shows a schematic diagram that the amount of information does not change after the information is expanded in the time domain, if the five information bits 10001 in FIG. 14 represent the data section of the wake up signal, then the data section before expansion occupies five symbols, the data section after expansion occupies ten symbols, but the data section is still 10001.

In some implementations, referring to FIG. 14, when the synchronization section, the reference section, and the data section of the wake up signal or the entire wake up signal is mapped and expanded, the synchronization section, the reference section, and the data section of the wake up signal or the entire wake up signal can be repeatedly replicated on the channel after being mapped and expanded, and when any one of a plurality of pieces of replicated information is correctly decoded, it means that the information is correctly received. It can be understood that when the partial information of the wake up signal or the entire wake up signal is repeatedly replicated on the channel, it is similar to the principle of repeated transmission of the wake up signal.

For example, referring to FIG. 14, if the five information bits 10001 in FIG. 14 represent a wake up signal, then the wake up signal before expansion occupies five symbols; after one expansion, the wake up signal is replicated into two wake up signals, the two wake up signals are both 10001, and the two wake up signals occupy 10 symbols in total. When any one of the two wake up signals is correctly decoded, it can represent that the data section is correctly received by the terminal.

It can be understood that mapping and expanding the information bit is not the same as mapping and expanding the synchronization section, the reference section, the data section, or the entire wake up signal.

Referring to FIGS. 13 and 14, taking an example that the first expansion indication field and the second expansion indication field are both 2, after the information bit is mapped and expanded, a time domain length occupied by one information bit is expanded from 1 symbol to 2 symbols; and after the data section is expanded, a time domain length occupied by the entire data section is expanded from 1 symbol to 2 symbols.

Through the above technical solution, the base station can send the second information to the terminal, the second expansion indication field carried in the second information indicates the expansion factor in the time domain of the at least one of the synchronization section, the reference section, or the data section of the wake up signal, or the entire wake up signal, so that the terminal can determine, based on the expansion factor, the resource position of the synchronization section, the reference section, and the data section of the received wake up signal or the entire wake up signal.

FIG. 8 shows a method for transmitting a wake up signal according to an example embodiment. The method is performed by a network device and includes the following step:
in step S801, at least two wake up signals are sent to a user equipment based on a configuration, and among the at least two wake up signals, two adjacent wake up signals are the same or partial information of the two adjacent wake up signals is the same.

The base station will send the at least two wake up signals to the terminal based on the configuration for the repeated transmission of the wake up signal in the time domain.

For example, the configuration or the configuration for the repeated transmission of the wake up signal in the time domain includes the number of repetitions of the repeated transmission of the wake up signal, and the base station will repeatedly send the wake up signal using the number of repetitions.

For example, the configuration includes the offset between the two adjacent wake up signals, and the base station will send the wake up signal using the offset.

For example, the configuration includes the position in the time domain of the repeatedly transmitted wake up signal among the wake up signals, and the base station will send the wake up signal at a resource position such as a designated symbol, the slot, or the sub-frame.

For example, the configuration includes the time domain resource occupied by the repeatedly transmitted wake up signal among the wake up signals, and the base station will send the wake up signal using the specified time domain resource length.

The partial information of the two adjacent wake up signals being identical may be that at least one of the information bit, the coded bit, the information bit group, the coded bit group, the data section, the synchronization section or the reference section of the two adjacent wake up signals is identical.

Through the above technical solution, the base station can send the at least two wake up signals to the terminal based on the configuration.

FIG. 9 shows a method for transmitting a wake up signal according to an example embodiment. The method is performed by a user equipment and includes the following step:
in step S901, indication information sent by a network device is obtained, the indication information is configured to indicate a configuration for repeated transmission of a wake up signal in a time domain, and the wake up signal is configured to indicate to the user equipment to change a sleep state of a receiver.

For the step S901, reference may be made to the above step S101, which will not be described in detail here.

Through the above technical solution, the terminal can receive the indication information sent by the base station, and the indication information indicates the configuration for the repeated transmission of the wake up signal in the time domain, so that the terminal determines, based on the configuration for the repeated transmission of the wake up signal in the time domain, at which resource positions the terminal itself receives the repeatedly transmitted wake up signal, and then the terminal uses at least one wake up signal among the received at least two wake up signals to change the sleep state of the receiver and complete the reception and transmission of uplink data and/or downlink data.

FIG. 10 shows a method for transmitting a wake up signal according to an example embodiment. The method is performed by a user equipment and includes the following step:
in step S1001, a wake up signal transmitted by a network device is received based on indication information.

The configuration indicated by the indication information carries the resource position where the base station sends the wake up signal, so the terminal can receive at the resource position specified by the configuration, based on the configuration, the wake up signal sent by the base station.

For the step S1001, reference may be made to the above step S801, which will not be described in detail here.

Through the above technical solution, the terminal can receive, based on the resource position indicated by the configuration, the wake up signal sent by the base station.

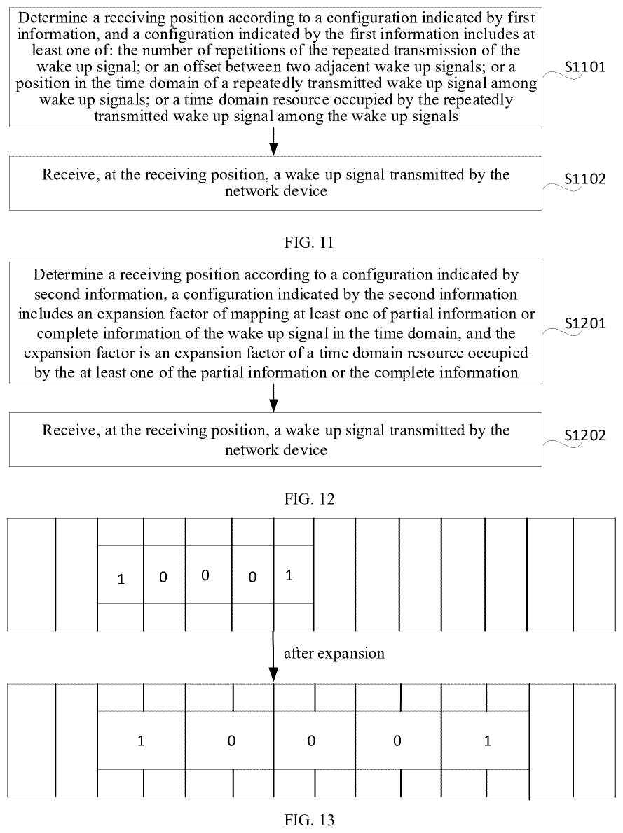

FIG. 11 shows a method for transmitting a wake up signal according to an example embodiment. The method is performed by a user equipment and includes steps S1101 and S1102.

In the step S1101, a receiving position is determined according to a configuration indicated by first information, and a configuration indicated by the first information includes at least one of: the number of repetitions of the repeated transmission of the wake up signal; or an offset between two adjacent wake up signals; or a position in the time domain of a repeatedly transmitted wake up signal among wake up signals; or a time domain resource occupied by the repeatedly transmitted wake up signal among the wake up signals.

The receiving position is a resource position where the terminal receives the wake up signal, and the resource position includes a starting resource occupied by the wake up signal and a time domain length occupied by the wake up signal. The starting resource may be a slot or a symbol.

In the step S1102, a wake up signal transmitted by the network device is received at the receiving position.

For the steps S1101 and S1102, reference may be made to the above step S201, which will not be described in detail here.

Through the above technical solution, the terminal can receive the first information sent by the base station. Since the first information carries the at least one of the number of repetitions of the repeated transmission of the wake up signal, the offset between the two adjacent wake up signals, the position in the time domain of the repeatedly transmitted wake up signal, or the time domain resource occupied by the repeatedly transmitted wake up signal among the wake up signals, the terminal can determine, based on at least one of the four pieces of information, the resource position of each wake up signal in the time domain, thereby determining the resource position where the terminal itself receives the wake up signal.

FIG. 12 shows a method for transmitting a wake up signal according to an example embodiment. The method is performed by a user equipment and includes steps S1201 and S1202.

In the step S1201, a receiving position is determined according to a configuration indicated by second information, a configuration indicated by the second information includes an expansion factor of mapping at least one of partial information or complete information of the wake up signal in the time domain, and the expansion factor is an expansion factor of a time domain resource occupied by the at least one of the partial information or the complete information.

In the step S1202, a wake up signal transmitted by the network device is received at the receiving position.

For the steps S1201 and S1202, reference may be made to the above step S501, which will not be described in detail here.

Through the above technical solution, the terminal can receive the second information sent by the base station, and the second information indicates the expansion factor in the time domain of the at least one of the information bit, the information bit group, the coded bit, or the coded bit group of the wake up signal, so that the terminal can determine, based on the expansion factor, the resource position of the at least one of the information bit, the information bit group, the coded bit, or the coded bit group of the received wake up signal.

A system for transmitting a wake up signal shown according to an example embodiment includes:
a network device, configured to send indication information to a user equipment, the indication information is configured to indicate a configuration for repeated transmission of a wake up signal in a time domain, and the wake up signal is configured to indicate to the user equipment to change a sleep state of a receiver; and
the user equipment, configured to receive the indication information sent by the network device.

FIG. 15 shows an apparatus for transmitting a wake up signal according to an example embodiment. The apparatus 150 for transmitting the wake up signal includes:
a sending module 151, configured to send indication information to a user equipment, the indication information is configured to indicate a configuration for repeated transmission of a wake up signal in a time domain, and the wake up signal is configured to indicate to the user equipment to change a sleep state of a receiver.

In some embodiments, the indication information includes first information, and a configuration indicated by the first information includes at least one of:
a number of repetitions of the repeated transmission of the wake up signal; or
an offset between two adjacent wake up signals; or
a position in the time domain of a repeatedly transmitted wake up signal among a wake up signal; or
a time domain resource occupied by the repeatedly transmitted wake up signal among the wake up signal.

In some embodiments, the offset between the two wake up signals in the time domain includes at least one of:
a number of slots offset between the two adjacent wake up signals; or
a number of symbols offset between the two adjacent wake up signals; or,
an absolute time interval offset between the two adjacent wake up signals.

In some embodiments, the number of slots offset between the two adjacent wake up signals includes:
a number of slots offset between a first slot carrying a first wake up signal among the two adjacent wake up signals and a second slot carrying a second wake up signal among the two adjacent wake up signals; and
the first slot includes a starting slot and an ending slot carrying the first wake up signal, and the second slot includes a starting slot and an ending slot carrying the second wake up signal.

In some embodiments, the number of symbols offset between the two adjacent wake up signals includes:
a number of symbols offset between a first symbol carrying a first wake up signal among the two adjacent wake up signals and a second symbol carrying a second wake up signal among the two adjacent wake up signals; and
the first symbol includes a starting symbol and an ending symbol carrying the first wake up signal, and the second symbol includes a starting symbol and an ending symbol carrying the second wake up signal.

In some embodiments, the position in the time domain of the repeatedly transmitted wake up signal among the wake up signal includes at least one of:
a starting slot carrying the repeatedly transmitted wake up signal; or,
a starting symbol carrying the repeatedly transmitted wake up signal.

In some embodiments, the time domain resource occupied by the repeatedly transmitted wake up signal among the wake up signal includes at least one of:
a number of slots occupied by the repeatedly transmitted wake up signal; or
a number of symbols occupied by the repeatedly transmitted wake up signal.

In some embodiments, time domain resources occupied by the two adjacent wake up signals are identical.

In some embodiments, frequency domain resources occupied by the two adjacent wake up signals are identical.

In some embodiments, the indication information includes second information, a configuration indicated by the second information includes an expansion factor of mapping at least one of partial information or complete information of the wake up signal in the time domain, and the expansion factor is an expansion factor of a time domain resource occupied by the at least one of the partial information or the complete information.

In some embodiments, the second information includes a first expansion indication field, the first expansion indication field is configured to indicate an expansion factor of mapping the partial information of the wake up signal in the time domain, and the partial information includes at least one of:
an information bit, an information bit group, a coded bit, or a coded bit group; and
information of the wake up signal before being encoded is carried by the information bit and the information bit group, and information of the wake up signal after being encoded is carried by the coded bit and the coded bit group.

In some embodiments, the second information includes a second expansion indication field, the second expansion indication field is configured to indicate the expansion factor of mapping the at least one of the partial information or the complete information of the wake up signal in the time domain, and the partial information includes at least one of:
a synchronization section, a reference section, or a data section; and
the synchronization section is configured to assist the user equipment in performing cell synchronization, the reference section is configured to assist the user equipment in determining an energy threshold, and the data section is configured to carry information of the wake up signal.

In some embodiments, the indication information includes at least one of:
Downlink Control Information (DCI), Media Access Control Control Element (MAC CE) or Radio Resource Control (RRC).

In some embodiments, the apparatus 150 for transmitting the wake up signal includes:
a sending module, configured to send at least two wake up signals to the user equipment based on the configuration, and among the at least two wake up signals, two adjacent wake up signals are identical or partial information of the two adjacent wake up signals is identical.

FIG. 16 shows an apparatus for transmitting a wake up signal according to an example embodiment. The apparatus 160 for transmitting the wake up signal includes:
a receiving module 161, configured to obtain indication information sent by a network device, the indication information is configured to indicate a configuration for repeated transmission of a wake up signal in a time domain, and the wake up signal is configured to indicate to a user equipment to change a sleep state of a receiver.

In some embodiments, the receiving module 161 is configured to receive, based on the indication information, a wake up signal transmitted by the network device.

In some embodiments, the indication information is first information, and the receiving module 161 includes:
a determination sub-module, configured to determine a receiving position according to a configuration indicated by the first information; and
a receiving sub-module, configured to receive at the receiving position the wake up signal transmitted by the network device;
the configuration indicated by the first information includes at least one of:
a number of repetitions of the repeated transmission of the wake up signal; or
an offset between two adjacent wake up signals; or
a position in the time domain of a repeatedly transmitted wake up signal among a wake up signal; or
a time domain resource occupied by the repeatedly transmitted wake up signal among the wake up signal.

In some embodiments, the indication information is second information, and the receiving module 161 includes:
a determination sub-module, configured to determine a receiving position according to a configuration indicated by the second information; and
a receiving sub-module, configured to receive at the receiving position the wake up signal transmitted by the network device;
the configuration indicated by the second information includes an expansion factor of mapping at least one of partial information or complete information of the wake up signal in the time domain, and the expansion factor is an expansion factor of a time domain resource occupied by the at least one of the partial information or the complete information.

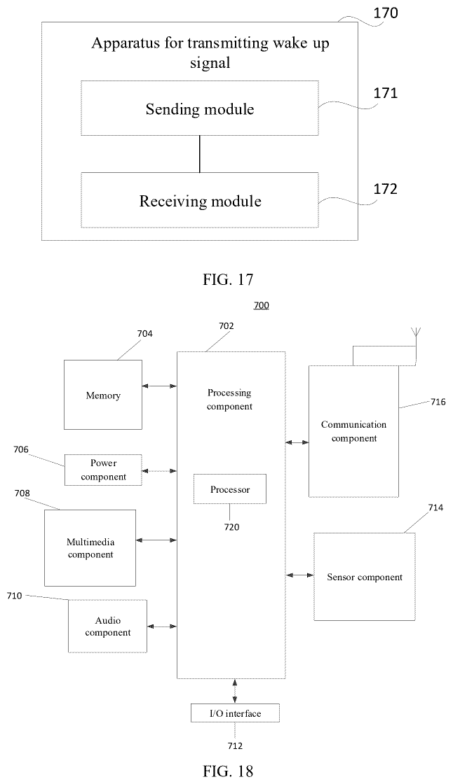

FIG. 17 shows an apparatus for transmitting a wake up signal according to an example embodiment. The apparatus 170 for transmitting the wake up signal includes:
a sending module 171, configured to send indication information to a user equipment, the indication information is configured to indicate a configuration for repeated transmission of a wake up signal in a time domain, and the wake up signal is configured to indicate to the user equipment to change a sleep state of a receiver; and
a receiving module 172, configured to receive the indication information sent by the network device.

FIG. 18 shows a block diagram of an electronic device 700 according to an example embodiment. For example, the electronic device 700 may be the user equipment described above, and the electronic device 700 may be a mobile phone, a computer, a digital broadcast terminal, a messaging device, a game console, a tablet device, a medical device, a fitness device, a personal digital assistant, etc.

Referring to FIG. 18, the electronic device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the electronic device 700, such as the operations associated with display, telephone calls, data communications, camera operations, and recording operations. The processing component 702 may include one or more processors 720 to execute instructions to complete all or part of the steps in the method for transmitting the wake up signal. Moreover, the processing component 702 may include one or more modules which facilitate the interaction between the processing component 702 and other components. For example, the processing component 702 may include a multimedia module to facilitate the interaction between the multimedia component 708 and the processing component 702.

The memory 704 is configured to store various types of data to support the operation of the electronic device 700. Examples of such data include instructions for any applications or methods operated on the electronic device 700, contact data, phonebook data, messages, pictures, video, etc. The memory 704 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the electronic device 700. The power component 706 may include a power management system, one or more power sources, and any other components associated with the generation, management, and distribution of power in the electronic device 700.

The multimedia component 708 includes a screen providing an output interface between the electronic device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 708 includes a front camera and/or a rear camera. The front camera and the rear camera may receive an external multimedia datum while the electronic device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (MIC) configured to receive an external audio signal when the electronic device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide state assessments of various aspects of the electronic device 700. For example, the sensor component 714 may detect an open/closed state of the electronic device 700, relative positioning of components, e.g., the display and the keypad, of the electronic device 700, a change in location of the electronic device 700 or a component of the electronic device 700, a presence or absence of user contact with the electronic device 700, an orientation or an acceleration/deceleration of the electronic device 700, and a change in temperature of the electronic device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the electronic device 700 and other devices. The electronic device 700 may access a wireless network based on a communication standard, such as Wi-Fi, 2G or 3G, or a combination thereof. In an embodiment, the communication component 716 receives a broadcast signal or broadcast associated information from an external broadcast management system via a broadcast channel. In an embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the electronic device 700 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for the method for transmitting the wake up signal.

In an embodiment of the present disclosure, there is further provided a non-transitory computer readable storage medium including instructions, such as the memory 704 including instructions, the above instructions may be executed by the processor 720 in the electronic device 700 for completing the method for transmitting the wake up signal. For example, the non-transitory computer-readable storage medium may be a ROM, a Random Access Memory (RAM), a CD-ROM, a magnetic tape, a floppy disc, an optical data storage device, and the like.

In addition to being an independent electronic device, the above-mentioned device may also be a part of the independent electronic device. For example, in an embodiment, the device may be an integrated circuit (IC) or a chip, where the integrated circuit may be an IC or a set of ICs; the chip may include but is not limited to: a graphics processing unit (GPU), a central processing unit (CPU), a field programmable gate array (FPGA), a digital signal processor (DSP), an application specific integrated circuit (ASIC), a system on chip (SoC, also called a system-level chip), etc. The above integrated circuit or chip may be used to execute executable instructions (or codes) to implement the above method for transmitting the wake up signal. The executable instructions may be stored in the integrated circuit or chip, or may be obtained from other apparatuses or devices. For example, the integrated circuit or chip includes a processor, a memory, and an interface for communicating with other devices. The executable instructions may be stored in the processor, and when the executable instructions are executed by the processor, the above method for transmitting the wake up signal is implemented; or the integrated circuit or chip can receive the executable instructions through the interface and transmit the executable instructions to the processor for execution, to implement the above method for transmitting the wake up signal.

In another example embodiment, there is further provided a computer program product including computer programs executable by a programmable device, and the computer programs have code portions that, when executed by the programmable device, cause the above method for transmitting the wake up signal to be performed.

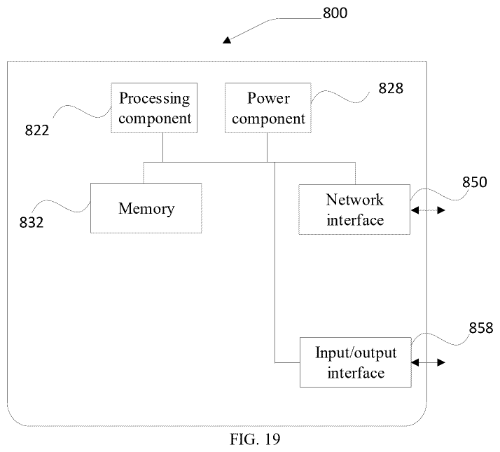

FIG. 19 shows a block diagram of an electronic device 800 according to an example embodiment. For example, the electronic device 800 may be provided as a network device. Referring to FIG. 19, the electronic device 800 includes a processing component 822, which further includes one or more processors and a memory resource represented by a memory 832 for storing instructions executable by the processing component 822, such as an application program. The application program stored in the memory 832 may include one or more modules, each corresponding to a set of instructions. In addition, the processing component 822 is configured to execute the instructions to execute the aforementioned method for transmitting the wake up signal.

The electronic device 800 may further include: a power component 828 configured to perform power management of the electronic device 800, a wired or wireless network interface 850 configured to connect the electronic device 800 to the network, and an input/output (I/O) interface 858. The electronic device 800 may operate an operating system stored in the memory 832.

Other embodiments of the present invention will be apparent to those skilled in the art from consideration of the specification and practice of the present invention disclosed here. This application is intended to cover any variations, uses, or adaptations of the present invention following the general principles thereof and including such departures from the present invention as come within known or customary practice in the art. It is intended that the specification and examples be considered as illustrative, with a true scope and spirit of the present invention being indicated by the following claims.

It will be appreciated that the present invention is not limited to the exact construction that has been described above and illustrated in the accompanying drawings, and that various modifications and changes can be made without departing from the scope thereof. It is intended that the scope of the present invention only be limited by the appended claims.

1. A method for transmitting a wake up signal, performed by a network device, and comprising:
sending indication information to a user equipment, wherein the indication information is configured to indicate a configuration for repeated transmission of a wake up signal in a time domain, and the wake up signal is configured to indicate to the user equipment to change a sleep state of a receiver.

2. The method according to claim 1, wherein the indication information comprises first information, and a configuration indicated by the first information comprises at least one of:
a number of repetitions of the repeated transmission of the wake up signal; of
an offset between two adjacent wake up signals; of
a position in the time domain of a repeatedly transmitted wake up signal among a wake up signal; or
a time domain resource occupied by the repeatedly transmitted wake up signal among the wake up signal.

3. The method according to claim 2, wherein the offset between the two adjacent wake up signals comprises at least one of:
a number of slots offset between the two adjacent wake up signals;
a number of symbols offset between the two adjacent wake up signals; or,
an absolute time interval offset between the two adjacent wake up signals.

4. The method according to claim 3, wherein the number of slots offset between the two adjacent wake up signals comprises:
a number of slots offset between a first slot carrying a first wake up signal among the two adjacent wake up signals and a second slot carrying a second wake up signal among the two adjacent wake up signals; and
wherein the first slot comprises a starting slot and an ending slot carrying the first wake up signal, and the second slot comprises a starting slot and an ending slot carrying the second wake up signal.

5. The method according to claim 3, wherein the number of symbols offset between the two adjacent wake up signals comprises:
a number of symbols offset between a first symbol carrying a first wake up signal among the two adjacent wake up signals and a second symbol carrying a second wake up signal among the two adjacent wake up signals; and
wherein the first symbol comprises a starting symbol and an ending symbol carrying the first wake up signal, and the second symbol comprises a starting symbol and an ending symbol carrying the second wake up signal.

6. The method according to claim 2, wherein the position in the time domain of the repeatedly transmitted wake up signal among the wake up signal comprises at least one of:
a starting slot carrying the repeatedly transmitted wake up signal; or,
a starting symbol carrying the repeatedly transmitted wake up signal.

7. The method according to claim 2, wherein the time domain resource occupied by the repeatedly transmitted wake up signal among the wake up signal comprises at least one of:
a number of slots occupied by the repeatedly transmitted wake up signal; or
a number of symbols occupied by the repeatedly transmitted wake up signal.

8. The method according to claim 2, wherein time domain resources occupied by the two adjacent wake up signals are identical; or
wherein frequency domain resources occupied by the two adjacent wake up signals are identical.

9. (canceled)

10. The method according to claim 1, wherein the indication information comprises second information, a configuration indicated by the second information comprises an expansion factor of mapping at least one of partial information or complete information of the wake up signal in the time domain, and the expansion factor is an expansion factor of a time domain resource occupied by the at least one of the partial information or the complete information.

11. The method according to claim 10, wherein the second information comprises a first expansion indication field, the first expansion indication field is configured to indicate an expansion factor of mapping the partial information of the wake up signal in the time domain, and the partial information comprises at least one of:
an information bit, an information bit group, a coded bit, or a coded bit group; and
wherein information of the wake up signal before being encoded is carried by the information bit and the information bit group, and information of the wake up signal after being encoded is carried by the coded bit and the coded bit group.

12. The method according to claim 10, wherein the second information comprises a second expansion indication field, the second expansion indication field is configured to indicate the expansion factor of mapping the at least one of the partial information or the complete information of the wake up signal in the time domain, and the partial information comprises at least one of:
a synchronization section, a reference section, or a data section; and
wherein the synchronization section is configured to assist the user equipment in performing cell synchronization, the reference section is configured to assist the user equipment in determining an energy threshold, and the data section is configured to carry information of the wake up signal.

13. (canceled)

14. The method according to claim 1, wherein the method further comprises:
sending at least two wake up signals to the user equipment based on the configuration, wherein among the at least two wake up signals, two adjacent wake up signals are identical or partial information of the two adjacent wake up signals is identical.

15. A method for transmitting a wake up signal, performed by a user equipment, and comprising:
obtaining indication information sent by a network device, wherein the indication information is configured to indicate a configuration for repeated transmission of a wake up signal in a time domain, and the wake up signal is configured to indicate to the user equipment to change a sleep state of a receiver.

16. The method according to claim 15, wherein the method further comprises:
receiving, based on the indication information, a wake up signal transmitted by the network device.

17. The method according to claim 16, wherein the indication information comprises first information, and a configuration indicated by the first information comprises at least one of:
a number of repetitions of the repeated transmission of the wake up signal; of
an offset between two adjacent wake up signals;
a position in the time domain of a repeatedly transmitted wake up signal among a wake up signal; or
a time domain resource occupied by the repeatedly transmitted wake up signal among the wake up signal.

18. The method according to claim 16, wherein the indication information comprises second information, a configuration indicated by the second information comprises an expansion factor of mapping at least one of partial information or complete information of the wake up signal in the time domain, and the expansion factor is an expansion factor of a time domain resource occupied by the at least one of the partial information or the complete information.

19-22. (canceled)

23. A network device, comprising:
a processor; and
a memory configured to store executable instructions of the processor;
wherein the processor is configured to implement the following operations when executing the executable instructions:
sending indication information to a user equipment, wherein the indication information is configured to indicate a configuration for repeated transmission of a wake up signal in a time domain, and the wake up signal is configured to indicate to the user equipment to change a sleep state of a receiver.

24. A user equipment, comprising:
a processor; and
a memory configured to store executable instructions of the processor;
wherein the processor is configured to implement steps of the method according to claim 15 when executing the executable instructions.

25. A non-transitory computer-readable storage medium having computer program instructions stored thereon, wherein the program instructions, when executed by a processor, implement steps of the method according to claim 1.

26. A chip, comprising a processor and an interface, wherein the processor is configured to read instructions to execute steps of the method according to claim 1.
